(19) United States
(12) Patent Application Publication
(10) Pub. No.: US 2016/0377204 A1
(43) Pub. Date: Dec. 29, 2016

(54) Potable Water Adapter for Beverage Equipment

(71) Applicant: Timothy C. Rock, Star Valley Ranch, WY (US)

(72) Inventor: Timothy C. Rock, Star Valley Ranch, WY (US)

(21) Appl. No.: 14/751,103

(22) Filed: Jun. 25, 2015

(51) Int. Cl. F16L 15/00; F16L 21/08

(52) U.S. Cl. CPC F16L 15/002; F16L 15/003; F16L 21/08

(57) ABSTRACT

A fitting with no moving parts or service technicians to attach between beverage equipment and water supply to make an uncommon connection of a ⅜ flared female fitting to a water valve having a ⅜ compression type outlet while in confined spaces with limited dexterity thus creating a water tight seal with minimal torque and compression of components to aide in the service of beverage equipment.

### BACK AND OF THE INVENTION

Beverage equipment such as Soda fountains, juice machines, Ice makers, coffee makers and similar devices are connected to potable water valves common in homes and businesses also called a stop. These valves most often use a ⅜ compression fitting for connection to the output of the stop.

A beverage hose usually of ⅜ inch inside diameter is most often used to connect equipment to the water supply. A common practice is to use stainless flare fittings having a female connection on one end of the hose attached to the equipment, to allow easy removal when needed. This connection would also be very convenient when added to the water supply end of the hose, but a simple adapter is not available for this purpose due to the unique thread combination and design of the compression fitting needs of the valve. Instead multiple parts not common in most hardware stores must be assembled costing more and have multiple joints to leak and are large in size creating other issues as well as wasted time and money. This Fitting is simple, and designed for installation in tight areas where it will be used often. It is designed specifically to connect a water valve outlet designed for ⅜ compression type fittings to the ⅜ stainless swivel nut and barbed stem, the stem being the connecting point of the ⅜″ hose leading to equipment.

### BRIEF SUMMARY OF THE INVENTION

To provide a easy to remove or install connection from a water supply to beverage equipment. This fitting is designed to be manipulated in tight places using no moving parts and having a large round knurled surface for better dexterity to install where water valves are often located in commercial settings behind cabinets and equipment. It could be made of bronze that is certified lead free 0.25 or less. The bronze allows for the elimination of the conical nylon gasket when used with a straight stem of accurate 45 degree tolerances. Other material could be used in the manufacture such as stainless steel but the conical nylon gasket would be needed between the flared male and female connections and it would lose a large benefit of its design. The elimination of this gasket is a very important in swing time since keeping this gasket in place while attaching the nut and stem is very hard and time consuming. The nylon gaskets fall off and get lost or become deformed in the stem and nut while tightening and is a common problem.

The inlet side of the Potable water beverage adapter has a recessed groove to allow the resilient gasket inside the fitting to extend past the outside diameter of the female threads at the inlet to flare fitting passage allowing the center between outside diameter and inside diameter of the water valve outlet to grip and create a seal on the gasket between the gaskets outside diameter and inside diameter thus capturing it to prevent movement of the gasket while tightening the fitting to the valve and creating a water tight seal. Both the inlet of the adapter which attaches to the valve and outlet of the adapter attaching to the swivel nut and stem, seal tight with minimal effort.

### BRIEF DESCRIPTION OF DRAWINGS:

FIG. 1

#10 The water valve

#9 Potable water adapter for beverage equipment

#6 Stainless stem with accurate 45 degree tolerances to match outlet of fitting

#7 Stainless nut for stem

#8 Beverage hose

FIG. 2

Cutaway of all parts assembled and their components.

#8 Beverage Hose

#6 Stainless stem with accurate 45 degree tolerances to match outlet of fitting

#7 Stainless nut

#5 45 degree surface for stem compression

#1 ⅝-18 UNF male threads

#9 Potable Water Adapter for Beverage Equipment

#3 Recessed resilient gasket

#7 9/16-74 NEF female threads

#10 Potable water valve or (stop)

FIG. 3

3D from bottom angle of Potable Water Adapter for Beverage Equipment

#1 ⅝-18 UNF male threads

#4 Knurled 1″ diameter finish

# 9/16-24 NEF female threads (inlet)

#3 Recessed resilient gasket

FIG. 4

3D from top angle of Potable Water Adapter for Beverage Equipment

#5 45 degree surface for stainless stem compression (outlet)

### DETAILED DESCRIPTION OF THE INVENTION

Looking at FIG. 2 of the drawings shows the cross section of the fitting and assembled parts.

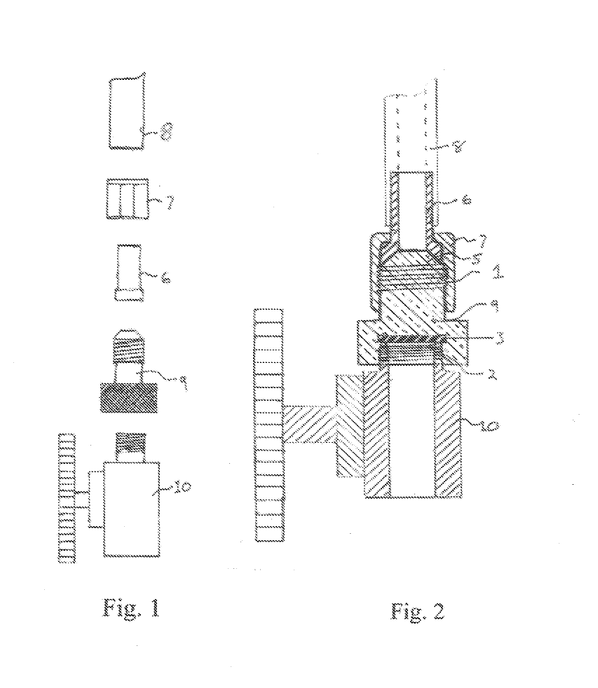

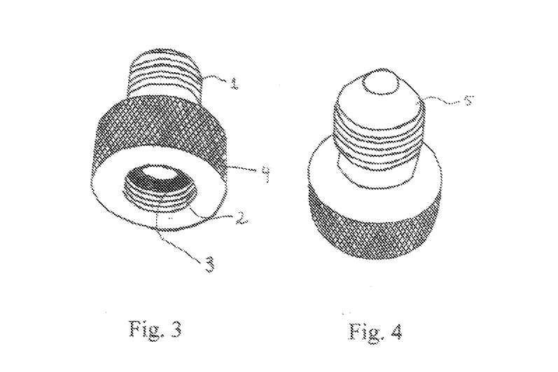

The Potable Water Adapter for Beverage Equipment FIG. 1 FIG. 2 #9 is machined of single piece bronze which meets 0.25% or less lead as required by the safe water drinking act or other solid material of required strength such as stainless steel. One end of this is one inch in diameter and has a knurled surface on the outside at its base FIG. 3 ITEM #4 allowing for easier grip and manipulation. The other end is reduced in size with a ⅝-18 external thread FIG. 2, FIG. 3 #1 to receive the stainless swivel nut FIG. 1 FIG. 2 #7 and at its top a 45 degree external flare FIG. 2 FIG. 4 #5 to receive the 45 degree female end of the stainless stem FIG. 1 FIG. 2 #6.

On the bottom of the fitting below the knurled surface FIG. 3 #2 is the inlet with 9/16-24 NEF threads to attach to the outlet of the valve with said ⅜ compression design. Inside the inlet of the fitting beyond the threads is a groove that extends past the threads towards the outside wall of the fitting with a resilient gasket FIG. 2 FIG. 3 #3.

Due to the design of the valve and the convex surfaces of the valves inlet on both OD and ID, if a gasket inserted into the inlet had a OD the same as the OD of the 9/16 threads and without having the groove, the seal could be pushed from its outside diameter to the middle of the cavity by curvature of the OD of the valve outlet opening. This is where the end of the valve outlet meets the seal in FIG. 2 #2 to #3 and could create a loss of integrity with the gasket used between the valve and fitting.

With the groove, the seal can extend past the threads and be captured by the center diameter of the valve outlet upon the center diameter of the gasket keeping it from moving and creating a seal when tightening by compression.

FIG. 1 Shows the components used in the installation of the equipment.

The Adapter #9 is threaded onto the valve #10.

The stem #6 goes through the nut #7 and the hose #8 is attached to the stem #6 and clamped.

The nut #7 is then tightened to the adapter #9

Slight torque on the nut is all that is needed to keep it secure, the adapter is hand tightened on the valve, no tools are needed for the adapter to valve and is not recommended. Slight torque with a wrench on the stainless nut can be used while holding the knurled section of the adapter secure to prevent over tightening. Fasten all loose hoses and make sure all is secure. If bronze is not used then the nylon conical shaped gasket must be placed between the adapter and the stainless stem.

My claim for this invention is

1. The adapter FIG. 1,2, #10 having external threads of ⅝ diameter and 18 threads per inch UNF FIG. 2 #1 with an external 45 degree conical end extending past the threads FIG. 2 #5 towards the center of the bore, this bore then leads to the opposite end of the adapter having internal threads 9/16 diameter 24 threads per inch NEF FIG. 2 #2.

2. The partially recessed gasket design comprised of a inside groove which is placed at the end of the female threads towards the inside of the fitting FIG. 2 #3 and extends outward past the outside diameter of the internal threads towards the outside diameter of the adapter allowing the outside diameter of the pipe, tubing or other object being compressed against the gasket to have an adequate amount of gasket extending past the outside diameter of the pipe, tubing, or other object when compressed allowing for a better seal. The inside diameter of the gasket is adjusted to the approximate size of the bore allowing for adequate amount of gasket to extend past the inside diameter as well.

3. The round gripping surface surrounding the fitting for ease of manipulation in tight spaces. The use of knurling or other texture may be applied for better grip.
